(19) United States
(12) Patent Application Publication
(10) Pub. No.: US 2003/0099739 A1
(43) Pub. Date: May 29, 2003

(54) Feed supplement for dairy animals and method

(76) Inventors: Timothy W. Clark, Menomonie, WI (US); Bruce Werner, New Richmond, WI (US)

Correspondence Address: INTELLECTUAL PROPERTY GROUP, FREDRIKSON & BYRON, P.A., 4000 PILLSBURY CENTER, 200 SOUTH SIXTH STREET, MINNEAPOLIS, MN, 55402, US

(21) Appl. No.: 09/971,812

(22) Filed: Oct. 5, 2001

(51) Int. Cl. A01K 1/00

(52) U.S. Cl. 426/2

(57) ABSTRACT

A feed supplement containing sodium diacetate and a sugar. The supplement may be added to the mixed feed of dairy animals in order to increase feed consumption and milk production. The supplement may also contain brewer's yeast, bentonite and/or sodium bicarbonate.

### BACKGROUND OF THE INVENTION

Many factors can affect the level of feed intake by dairy animals. The feed may lose sugars during storage due to fermentation. Mold growth can occur due to the moisture content of the feed and the increased heat due to the fermentation. These factors lead to decreased palatability of the feed for the dairy animal.

Sodium diacetate has been used for years to inhibit mold growth in stored grain and haylage as taught in U.S. Pat. No. 4,514,425. It has also been used as an attractant for dairy animals to enhance the taste of their feed as taught in U.S. Pat. Nos. 3,925,559, 4,178,369, and 4,338,336. Sodium diacetate is an equimolar compound of acetic acid and its sodium salt which acts as a buffer to prevent the decrease of the pH in the rumen, thereby restraining the destruction of essential rumen microbes which improves nutrient utilization. Soluble sugars have been utilized to help control rumen pH, as seen in U.S. Pat. Nos. 6,033,609 and 6,126,986.

Ambient and internal stress conditions on dairy animals can occur. As ambient temperatures rise above 72 degrees Fahrenheit, lactating dairy animals have a significant increased metabolic stress, thereby requiring more nutrients. Increased temperature also leads to fermentation and mold growth of storage feed thereby decreasing palatability and nutrient value. Internal stress and subsequent increasing nutrition needs for dairy animals also occurs with several physiologic changes. Dairy animals can have greatly reduced feed intake and milk production from calving through the first 30 days of lactation. This is particularly true for first time heifers. This is explained by the developing rumen that cannot metabolize and absorb food efficiently for caloric needs. There is a need for a feed supplement that would significantly improve both feed consumption and milk production in dairy animals.

### BRIEF SUMMARY OF THE INVENTION

We have found that an unexpected increase in both feed intake and milk production results from administering to dairy animals a feed containing an additive that contains effective amounts of both sodium diacetate and a sugar such as dextrose.

Thus, in one embodiment, the invention relates to a method of improving the maintenance of weight and milk production of dairy animals by giving a feed supplement with a mixture of sodium diacetate and a sugar.

In another embodiment, the invention relates to a feed additive comprising sodium diacetate and a sugar that with mixed feed comprises a feed to increase the weight and milk production of lactating dairy animals.

In a preferred embodiment, the feed supplement contains approximately equal amounts of sodium diacetate and a sugar, preferably dextrose. The percentage by weight each of sodium diacetate and the sugar in the mixed feed after addition of the feed supplement is about 0.09% to about 0.35%. Fillers in the supplement may be brewer's yeast, bentonite, and/or sodium bicarbonate. These fillers are present , if at all, in a combined concentration of not greater than 50% by weight of the feed supplement.

### DETAILED DESCRIPTION OF THE PREFERRED EMBODIMENT

In the present invention, a composition containing a combination of ingredients are combined with the total mixed ration fed to dairy ruminants for the improvement of feed intake and milk production. The composition is added to the total mixed ration fed to cattle to prevent heating of the mixed ration, inhibit mold growth, and improve the rumen environment to promote the growth of beneficial rumen microbes. The unexpected substantial effects of the combination of ingredients in the invention are increases in feed intake and rumen function efficiencies.

Sodium diacetate and dextrose or other sugars are the major effective components of the composition. Sodium diacetate is non-toxic to humans and animals. This agent is not corrosive to equipment and may be safety handled using standard precautions. Dextrose is a simple sugar refined from cornstarch. Dextrose is produced by enzymatic conversion of cornstarch and then refined by ion-exchange demineralization. The composition may also include a mineral blend, yeast culture, and inert non-nutritional carriers and free-flowing agents. The mineral blend is a mixture of magnesium oxide and sodium bicarbonate. The yeast culture is a mixture of killed yeast, growth medium, and yeast metabolites. The mineral blend does have some alkalizing effect in the rumen, but the total inclusion rate in the feed as contributed from the invention is at a range of 3% to 8% of the recommended efficacious level. Yeast culture has been added to the feed for cattle to increase production with mixed results. The inclusion rate of yeast in the feed as contributed by the invention is at a range of 8% to 20% of the recommended efficacious level. The inert carriers and free-flowing agents are bentonite, a silicate compound and sodium aluminosilicate, an anti-caking agent. In general, sodium diacetate and dextrose or other sugar comprise 50% to 80% of the additive composition. The other ingredients are of similar texture and bulk density to sodium diacetate and dextrose resulting a homogeneous stable composition of the invention. Sodium diacetate and dextrose appear to work in a synergistic manner, providing the rumen bacteria with a source of rapidly fermentable carbohydrate while maintaining a consistent rumen pH. Feed intake of dairy cattle is a function of rumen fill, rumen digestion rate, and rumen passage rate. Rumen bacterial concentrations, rumen nutrient availability and rumen pH influence rumen digestion rate. Ruminal microbes require an energy source. Ruminal microbe energy sources include sugars, starches and plant fiber. Sugars digest very rapidly, starches digest more slowly, and fiber sources digest very slowly. Rumen bacteria require a balanced supply of energy and nutrients to grow at an optimum rate. The greater the concentration of rumen bacteria the faster the fiber portion of the diet can be digested. The rate at which fiber is digested in the rumen is often the limiting factor for feed consumption. The primary fiber source in dairy animal diets is farm-raised forages. Forages comprise the highest percentage of a dairy animal's diet and maximizing the amount of forage is beneficial to the animal's health and the dairy producer's economic success. The faster the fibrous material passes through the rumen, the faster the dairy animal can consume more of the total diet. However, rumen microbes are very sensitive to pH. The microbes that digest fiber do not grow and function well in an acidic environment. When energy sources are digested in the rumen they are fermented to volatile fatty acids. The digestion of sugars and starches result in the production of propionic acid, a strong acid that will rapidly lower rumen pH. The digestion of fiber results in the production of acetic acid, a weak acid that will not greatly lower rumen pH. The objective of the invention was to provide a means of supplying a rapidly fermentable carbohydrate source for the rumen bacteria while maintaining a rumen pH that would enhance and stimulate fiber digestion in the rumen.

Dextrose provides a soluble carbohydrate source that often is lacking in the diet of dairy cattle. A large portion of dairy cattle diets is composed of fermented forage called silage. Forage fermentation is necessary to allow for year round storage. However, the fermentation process depletes the natural sugars that are present in fresh forage. During silage fermentation, bacteria naturally occurring on the forage use the plant sugars to produce lactic acid. Lactic acid lowers the pH of the forage to where it is stable enough for long term storage. Hay crops, such as alfalfa are naturally low in plant sugars. When such hay crops are used to make silage, almost all of the plant sugar is depleted during fermentation. The dextrose provided by the invention replaces a portion of the sugars that are lost during silage fermentation. The dextrose provides a rapidly digestible energy source for the rumen microbes. This energy allows for earlier bacterial growth compared to when the dextrose is not present. This early bacterial growth results in higher total bacteria concentrations that can better utilize the starch portion of the diet, as it becomes available. This increased bacterial growth and nutrient utilization results in increased fiber digestion. The increased fiber digestion results in a faster rate of passage through the rumen allowing for increased feed intake by the dairy cow.

The sodium diacetate in the invention is believed to work in conjunction with the dextrose by limiting the drop in rumen pH associated with the fermentation of rapidly digestible carbohydrate sources such as sugars. If a large amount of carbohydrate is fed without a buffer the rumen pH will drop, continuing to decline as more carbohydrates are digested. As rumen pH declines, rumen bacteria are destroyed and forage digestion slows or even stops. This causes the animal to eat less due to the increased time needed to empty the rumen. Sodium diacetate is a natural buffer that will aid in maintaining a more consistent rumen pH. Sodium diacetate does not have alkalizing characteristics such as other buffers, but it works to prevent rapid changes in rumen pH, maintaining a constant pH allowing for continued starch and fiber digestion.

The feed supplement is supplied in bags as a dry powder that is mixed with a variety of feed chosen by the user. The constituents in the bag have been mixed thoroughly and are not separated when applied to the mixed feed. The ratio of a sugar to the supplement is approximately 0.2 to 0.4. The ratio of the sodium diacetate to the supplement is approximately 0.2 to 0.7. Six pounds of the supplement is applied to approximately 2000 pounds of mixed feed to give the feed that improves weight and milk production in dairy animals. The invention will be further illustrated but not limited by the following examples.

### EXAMPLE 1

In order to evaluate the combination of sodium diacetate and dextrose in a feed supplement, a trial was conducting on a farm with 460 lactating dairy cows. This farm was experiencing low feed intake due to the poor quality of the haylage available. The design of the study was a switch back design. Feed intake, whole farm milk production and individual group milk production were monitored for 2 weeks prior to the addition of the sodium diacetate and dextrose mixture, for 3 weeks during the addition of the sodium diacetate and dextrose mixture, and for 2 weeks after the sodium diacetate and dextrose mixture was removed from the diet. The animals were grouped according to age, stage of lactation, and milk production level. The animal grouping was as follows:

| Group | Description |
|---|---|
| High Cows | Mature cows greater than 30 days in milk. |
| Heifer | First calf heifers greater than 30 days in milk. |
| Mixed | Cows and heifers less than 30 days in milk and cows and |
| | heifers within two weeks of the end of the current lactation. |
| Low Cows | Cows that were greater than 200 days in milk. |

Individual cow and group milk production was recorded daily by the farm using a computerized record system. Whole farm milk production was determined by recording the amount of total milk shipped from the farm as reported by the milk processing plant. Feed consumption was determined by recording amounts fed per group and adjusting for the amount not consumed from the prior day. During the trial the animals were fed a diet consisting of 5 pounds hay, 25 pounds haylage, 32 pounds corn silage, 16 pounds ground corn, and 8 pounds of a protein supplement per day. The sodium diacetate and dextrose mixture was fed at 6 pounds per ton of complete diet during the 3-week supplementation phase of the trial.

With the addition of the sodium diacetate and dextrose mixture, the cows consumed 1.86 pounds per day more feed on a dry matter basis and produced 3.9 pounds per day more milk compared to when the invention was not fed. Tables I and II show feed intake and milk production response.

TABLE I
Feed Intake Response - Pound Dry Matter Consumed Per Day Per Cow

| | | Control Period | | Test Period | | |
|---|---|---|---|---|---|---|
| Group | Number | Lbs. | S.D.- | Lbs. | S.D.- | Change |
| High Cows | 120 | 53.42 | 1.69 | 54.63 | 0.62 | +1.21 |
| Heifers | 123 | 42.68 | 1.27 | 43.76 | 0.45 | +1.08 |
| Mixed | 93 | 35.08 | 1.67 | 38.38 | 2.30 | +3.30 |
| Low Cows | 120 | 49.61 | 1.94 | 51.45 | 1.67 | +1.84 |
| Average | | 45.19 | | 47.05 | | +1.86 |

TABLE II
Milk Production Response - Average Pounds Per Day Per Cow

| | | Control Period | | Test Period | | |
|---|---|---|---|---|---|---|
| | Number | Lbs. | S.D. | Lbs. | S.D. | Change |
| High Cows | 120 | 100.5 | 1.69 | 101.9 | 0.79 | +1.4 |
| Heifers | 123 | 74.6 | 1.27 | 76.8 | 0.91 | +2.3 |
| Mixed | 93 | 49.7 | 2.04 | 51.9 | 0.82 | +2.2 |
| Low Cows | 120 | 70.1 | 0.86 | 72.2 | 0.85 | +2.1 |
| Early Heifers | 38 | 49.6 | 1.12 | 57.6 | 1.30 | +8.0 |
| Early Cows | 30 | 67.6 | 0.80 | 72.8 | 1.20 | +5.2 |
| Whole Farm | | 77.6 | | 81.5 | | +3.9 |

Control period is the two weeks prior to and two weeks after the invention was applied.

Test period is the three weeks while the invention was applied.

The combination of sodium diacetate and dextrose in the invention did result in a more consistent rumen environment as indicated by the lower standard deviation in feed intake when the invention was fed compared to when the invention was not fed. The more consistent and increased fed intake resulted in higher milk production. Less day to day variation in feed intake and milk production suggest that rumen function was more optimum while the invention was being fed.

The groups that showed the largest improvement in feed intake were early lactation heifers and cows as seen with an increase of 3.3 pound dry matter. The milk production response for early lactation heifers and cows were 8.0 and 5.2 pounds per day, respectively. These animals are under the most stress and have the lowest initial feed intakes. These animals also have higher nutritional requirements, but do not have high feed intakes compared to animals in later lactation. Any improvement in feed intake greatly reduces the metabolic stress of these animals. These animals have not yet reached maximum dry matter intake due to the fact that their rumens have not fully adapted to a lactating cow diet. The sodium diacetate and dextrose mixture enhances feed intake and provides nutrients that promote rumen bacteria adaptation, greatly improving the efficiency of this group of animals. All groups showed increased feed intake and milk production. As mentioned earlier, the feed intakes and milk production levels were much more consistent, suggesting that rumen function and efficiency was increased in all animals.

### EXAMPLE 2

A separate trial was conducted on a commercial dairy to determine the effectiveness of the sodium diacetate and dextrose mixture in increasing production in dairy cattle during the period immediately after calving and during the first 30 days of lactation. The farm milked 800 cows. Animals were grouped according to age and stage of lactation. There were 9 feeding groups with the following description:

| | | Days in |
|---|---|---|
| Group | Description | Milk |
| Post calving | Cows and heifers immediate after calving. | 1-12 |
| Early cows | Mature cows in early lactation | 12-30 |
| Early heifers | Heifers in early lactation | 12-30 |
| Cows - 3 groups | Mature cows in mid to late lactation | 30-400 |
| Heifers - 3 groups | Heifers in mid to late lactation | 30-400 |

The invention was fed in the post calving, early cows and early heifers groups. Milk production was monitored for 7 days prior to feeding the invention and during the 21-day supplementation period. Milk production of all control groups was monitored to serve as on-farm controls. Comparisons were made before and after supplementation within group. The change in production was compared between supplemented groups and control groups. Results are presented in Table III.

TABLE III
Milk Production Response - Average Pounds Per Day Per Group

| | Control Period | | Test Period | | |
|---|---|---|---|---|---|
| Number | Lbs. | S.D. | Lbs. | S.D. | Change |

Sodium Diacetate and Dextrose Added

| | | | | | | |
|---|---|---|---|---|---|---|
| Post calving | 30 | 41.3 | 1.43 | 47.5 | 0.97 | +6.2 |
| Early cows | 95 | 74.6 | 1.27 | 76.8 | 0.95 | +2.3 |
| Early heifers | 104 | 49.7 | 1.77 | 51.9 | 0.88 | +2.1 |

Sodium Diacetate and Dextrose - Not Added

| | | | | | | |
|---|---|---|---|---|---|---|
| Cow group 1 | 120 | 76.6 | 0.86 | 76.6 | 0.85 | nil |
| Cow group 2 | 110 | 75.8 | 1.04 | 73.9 | 0.97 | −1.9 |
| Cow group 3 | 98 | 75.7 | 1.15 | 75.2 | 1.10 | −0.5 |
| Heifer group 1 | 100 | 61.2 | 0.80 | 61.9 | 1.20 | +0.8 |
| Heifer group 2 | 118 | 67.3 | 1.40 | 66.0 | 0.94 | −1.3 |
| Heifer group 3 | 106 | 68.3 | 0.96 | 68.1 | 1.08 | −0.2 |

Control period is the one-week prior to the invention being applied.

Test period is the three weeks while the invention was applied to the post calving, early cows and early heifers groups.

This trial clearly shows that the addition of the sodium diacetate and dextrose mixture increased milk production of animals in early lactation compared to before the invention was added. There was a substantial increase in production of the post calving group. This supports the claim that the invention improves performance of dairy cattle during the immediate post- partum period. Comparing supplemented groups to control groups during the same time period shows that adding the sodium diacetate and dextrose mixture increased milk production in the supplemented groups while production declined in 5 of the 6 control groups. Production was more consistent in supplemented animals as indicated by the lower standard deviation, suggesting that the addition of the sodium diacetate and dextrose mixture improved rumen function of the early lactation animals. The fact that the post calving group had the largest increase in milk production of 6.2 pounds indicates improved rumen adaptation of dairy cattle in the immediate post-calving period.

While a preferred embodiment of the present invention has been described, it should be understood that various changes, adaptations and modifications may be made therein without departing from the spirit of the invention and the scope of the appended claims.

1. A method of increasing the feed intake and milk production of lactating dairy animals comprising administering to such animals a feed supplement comprising a mixture of effective amounts of sodium diacetate and sugar.

2. The method of claim 1 including the step of adding said supplement to mixed feed to produce a feed that is then administered to such animals.

3. The method of claim 1 wherein the weight ratio of sodium diacetate to said supplement is in the range of about 0.2 to 0.7.

4. The method of claim 1 wherein the weight ratio of sugar to said supplement is in the range of about 0.2 to 0.4.

5. The method of claim 1 wherein said sugar comprises monosaccharide or a disaccharide.

6. The method of claim 1 wherein said sugar comprises a monosaccharide selected from the group consisting of dextrose, glucose, fructose and D-ribose.

7. The method of claim 1 wherein said sugar comprises a disaccharide selected from the group consisting of sucrose and maltose.

8. The method of any one of claims 2-4 wherein the percentage by weight of said sugar in said feed is in the range of about 0.09% to 0.35%.

9. The method of any one of claims 2-4 where the percentage by weight of said sodium diacetate in said feed is in the range of about 0.09% to 0.3%

10. The method of claim 1 wherein said supplement additionally contains one or more of brewer's yeast, bentonite and sodium bicarbonate.

11. The method of claim 1 wherein said supplement contains two or more of brewer's yeast, bentonite and sodium bicarbonate.

12. The method of claim 9 or claim 10 wherein the total amount by weight of brewer's yeast, bentonite and sodium bicarbonate is not greater than about 50% of the weight of said supplement.

13. The method of claim 1 wherein the dairy animal is bovine, ovine or caprine.

14. The method of claim 1 wherein said supplement is administered to dairy animals throughout substantially the entire period of lactation.

15. A feed for lactating dairy animals which comprises a mixed feed and, as a feed supplement, a mixture of sodium diacetate and sugar in effective amounts to increase the weight and milk production of said animals.

16. The feed of claim 15 wherein the percentage by weight of said sugar in said feed is in the range of about 0.09% to 0.35%.

17. The feed of claim 15 wherein the percentage by weight of sodium diacetate in said feed is in the range of about 0.09% to 0.3%.

18. The feed of claim 15 wherein the weight ratio of sodium diacetate to said supplement is in the range of about 0.2 to 0.7.

19. The feed of claim 15 wherein said sugar comprises a monosaccharide selected from the group consisting of dextrose, glucose, fructose and D-ribose.

20. The feed of claim 15 wherein said sugar comprises a disaccharide selected from the group consisting of sucrose and maltose.

21. The feed of claim 15 wherein said feed supplement additionally contains one or more of brewer's yeast, bentonite and sodium bicarbonate.

22. The feed of claim 1 wherein said feed supplement contains two or more of brewer's yeast, bentonite and sodium bicarbonate.

23. The feed of claim 21 or claim 22 wherein the total amount by weight of brewer's yeast, bentonite and sodium bicarbonate is not greater than about 50% of the weight of said supplement.

24. A feed supplement to be added to mixed feed for increasing the weight and milk production of lactating dairy animals, comprising a mixture of effective amounts of sodium diacetate and sugar

25. The feed supplement of claim 24 wherein the weight ratio of said sugar to said supplement is in the range of about 0.2 to 0.4.

26. The feed supplement of claim 24 wherein said sugar comprises a monosaccharide or a disaccharide.

27. The feed supplement of claim 24 wherein said sugar comprises a monosaccharide selected from the group consisting of dextrose, glucose, fructose and D-ribose.

28. The feed supplement of claim 24 wherein said sugar comprises a disaccharide selected from the group consisting of sucrose and maltose.

29. The feed supplement of claim 24 wherein the weight ratio of said sodium diacetate to said supplement is in the range of about 0.2 to 0.7.

30. The feed supplement of claim 24 additionally containing one or more of brewer's yeast, bentonite and sodium bicarbonate.

31. The feed supplement of claim 24 contains two or more of brewer's yeast, bentonite and sodium bicarbonate.

32. The feed supplement of claim 30 or claim 31 wherein the total amount by weight of brewer's yeast, bentonite and sodium bicarbonate is not greater than about 50% of the weight of said supplement.
